(19) United States
(12) Patent Application Publication
(10) Pub. No.: US 2022/0271966 A1
(43) Pub. Date: Aug. 25, 2022

(54) SYSTEM AND METHOD FOR MOBILE DEVICE FLEET MANAGEMENT

(71) Applicant: Toshiba TEC Kabushiki Kaisha, Shinagawa-ku (JP)

(72) Inventors: Guillermo Hernandez GALLEGOS, Jalisco (MX); Carlos Perez HERMOSILLO, Jalisco (MX); Kevin Marquez VACA, Jalisco (MX); Javier GONZALEZ, Jalisco (MX); Daniel Garcia Zuñiga, Jalisco (MX)

(21) Appl. No.: 17/183,659

(22) Filed: Feb. 24, 2021

(51) Int. Cl. H04L 12/18

(52) U.S. Cl. CPC H04L 12/1863; H04L 12/184; H04L 12/1859; H04L 12/189

(57) ABSTRACT

A system and method for managing fleets of network MFPs uses a portable data device such as a networked smartphone to discover and query devices over one or more network subnets. The smartphone sends out a multicast device discovery petition to all network devices and processes responses received asynchronously in parallel. A sequence of smaller multicasts can be used so as not to overwhelm available device resources. Once all devices has responded, all responses are checked sequentially. Devices identified as multifunction peripherals are sent a second petition seeking device state information. Received device state information is stored in a management database.

### TECHNICAL FIELD

This application relates generally to device monitoring. The application relates more particularly to management of fleets of multifunction peripherals by the use of a handheld digital device.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Large businesses may have a large number of MFPs, referred to as a fleet. MFPs must be monitored for configuration, hardware or software or firmware modification, consumable replenishment, usage monitoring, or the like. Such monitoring requires periodically getting information from MFPs in the fleet.

### BRIEF DESCRIPTION OF THE DRAWINGS

Various embodiments will become better understood with regard to the following description, appended claims and accompanying drawings wherein:

FIG. 1 an example embodiment of a of a system for mobile device fleet management;

FIG. 2 is an example embodiment of a networked digital device comprising a document rendering system;

FIG. 3 is an example embodiment of a digital device system such as a smartphone or tablet; and

FIG. 4 flowchart of an example embodiment of a system for mobile device fleet management.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

Fleet management can be accomplished via a networked computer, such as a workstation. Device information may be secured in this fashion for device maintenance, updating, modification or replenishment. However, since most, if not all MFPs are in different locations, an administrator may have to regularly return to their workstation to determine different device needs or properties as the service devices scattered about a premises. It is thus desirable to undertake MFP fleet management with a handheld device such as a smartphone or tablet. In order to accomplish management, a device must first identify all MFPs of interest on one or more subnets of interest. Device discovery can use more resources than is available on a mobile device.

Example embodiments herein provide a device discovery process accomplished via a handheld device, such as smartphone or tablet computer. The system discovers multiple MFP devices across different networks, wired or wireless or a combination of both. This discovery process is typically a heavy, resource consuming operation which can overwhelm resources available on a handheld device, such as tablet or smartphone. The system enables a mobile handheld device to accomplish discovery of potentially hundreds of MFP's efficiently and in an asynchronous or parallel fashion. A multistep MFP device discovery process is used to accomplish effective device discovery within a mobile device with restricted resources. This routine can traverse local area networks (LANs), area networks (WANs), multiple subnets, virtual LANs (VLANS) and network segments, even if connected through a virtual private network (VPN). The system suitably uses an existing protocol, such as the Simple Network Management Protocol (SMNP) for MFPs so enabled devices in a multistep, parallel execution process. The system implements a software library configured to handle up to several hundreds of MFP petitions and replies to discover a fleet of MFP devices.

After device discovery, which could be hundreds of MPFs within a network, one or fleets can be created for efficient MFP management of the MFP. Each fleet MFP is associated with an IP address and configured to be failure tolerant. If an IP address becomes unreachable, failure tolerant devices adapt to the new network conditions.

In example embodiments, a mobile device analyzes its own network, then sends a multicast petition to traverse its own subnet in a search in a parallel fashion. The mobile device is configured to decide intelligently how to send these petitions. In a subnet defined by an octet of 255 IP addresses, up to 254 in an IP addresses and/or devices may be available in the handheld device's own subnet.

When the devices of interest, such as SMNP compatible MFPs, receive this petition they will most likely be in power saving mode. This petition initially functions to “wake up” MFPs out of power saving mode becoming fully functional. Since the petition is broadcast in parallel, devices respond in an asynchronous matter. The system determines if a replying device is of interest. If so, it will initiate a second petition as a second stage inquiry. This second stage inquiry will use another set of petitions to query for manufacture name, model name and other details, such as an installed software, installed hardware, firmware version, copy count, consumable levels, error codes, and the like. Processing is asynchronous, so the system suitably balances the outgoing petition load, to manage a rate of incoming replies to allow sufficient device resources to handle messaging as it is received in parallel achieving up to 600% improved processing time compared to a traditional, linear device discovery process.

Discovered MFP's are suitably stored in a local database for easy administrator management via their mobile device. When traversing a particular subnet is completed, the system can move to another subnet, allowing fine tuning by the administrator. If a mobile device has sufficient capabilities, several subnets can be traversed by concurrently implementing parallel operations.

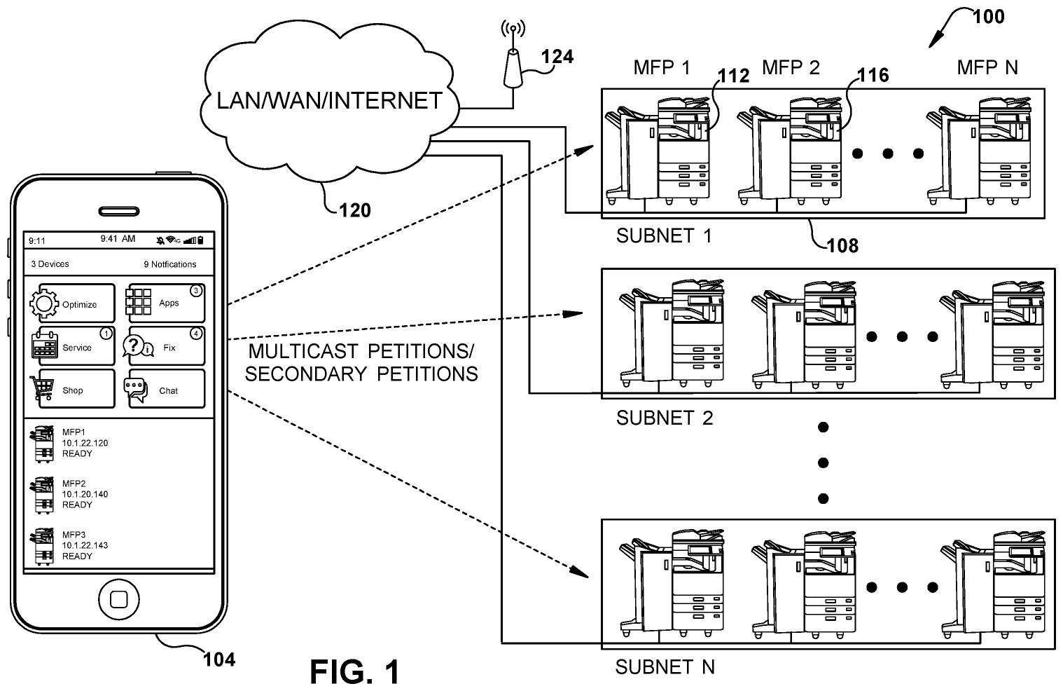

FIG. 1 illustrates an example embodiment of a system 100 for mobile device fleet management. In the illustrated example, management is via smartphone 104. Management is for one or more fleets of one or more MFPs. The system includes a fleet of MFPs over a plurality of subnets. A first subnet 108 will be discussed in detail, but it is to be understood that such teaching is applicable to all other fleet subnets. Subnet 108 includes a first MFP 112, and one or more additional MFPs, including MFP 116. MFPs are in data communication, in any suitable wireless or wired configuration, with smartphone 104 via network cloud 120. Network cloud 120 is suitably comprised of a LAN, WAN, which may comprise the Internet, or any suitable combination thereof. Smartphone 104 is suitably in network data communication with network cloud 120 via Wi-Fi hotspot 124, and itself has an IP address in subnet 1. Smartphone 104 sends its multicast petitions and secondary petitions to devices in subnet 108, and determines from their replies whether they are of interest as being SNMP configured MFPs. Devices of interest are queried for device state information of interest, such as installed software, installed hardware, firmware version, consumable level, error codes and device usage levels.

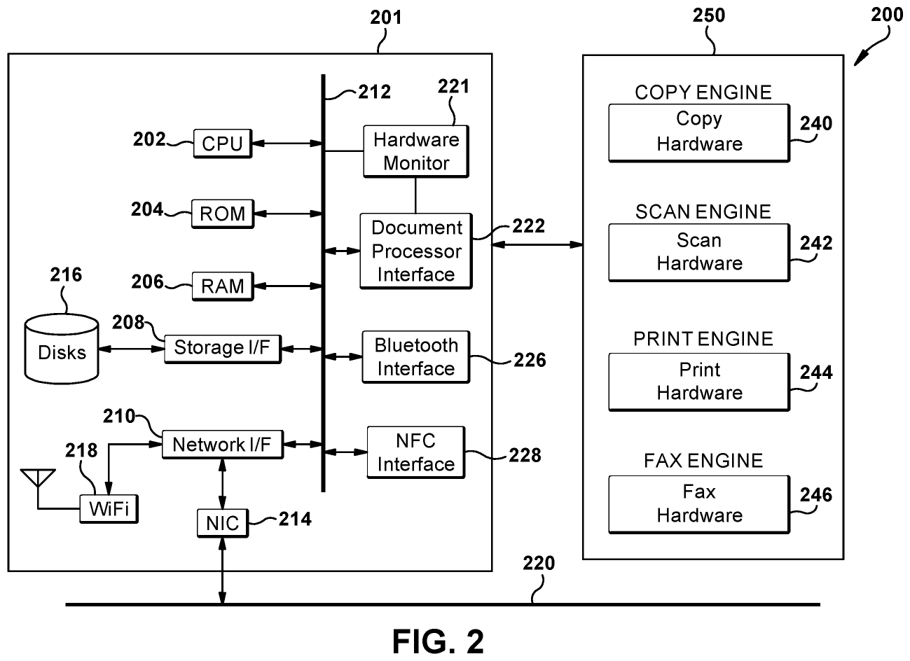

Turning now to FIG. 2, illustrated is an example embodiment of a networked digital device comprised of document rendering system 200 suitably comprised within an MFP, such as with MFPs of FIG. 1. It will be appreciated that an MFP includes an intelligent controller 201 which is itself a computer system. Thus, an MFP can itself function as a server with the capabilities described herein. Included in intelligent controller 201 are one or more processors, such as that illustrated by processor (CPU) 202. Each processor is suitably associated with non-volatile memory, such as read-only memory (ROM) 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired interface or physical network connection 220, or to a wireless data connection via wireless network interface 218. Example wireless data connections include cellular, Wi-Fi, Bluetooth, NFC, wireless universal serial bus (wireless USB), satellite, and the like. Example wired interfaces include Ethernet, USB, IEEE 1394 (FireWire), Lightning, telephone line, or the like. Processor 202 is also in data communication with user interface 21 for interfacing with displays, keyboards, touchscreens, mice, trackballs and the like.

Processor 202 can also be in data communication with any suitable user input/output (I/O) interface 219 which provides data communication with user peripherals, such as displays, keyboards, mice, track balls, touch screens, or the like.

Also in data communication with data bus 212 is a document processor interface 222 suitable for data communication with the document rendering system 200, including MFP functional units. In the illustrated example, these units include copy hardware 240, scan hardware 242, print hardware 244 and fax hardware 246 which together comprise MFP functional hardware 250. It will be understood that functional units are suitably comprised of intelligent units, including any suitable hardware or software platform.

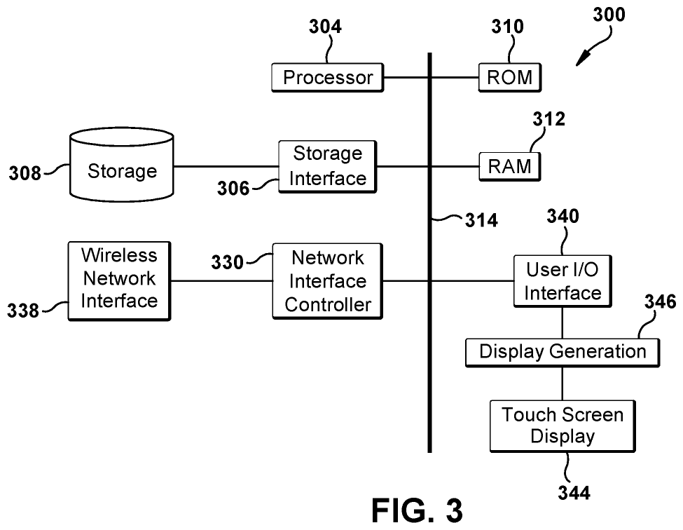

Turning now to FIG. 3, illustrated is an example embodiment of a digital data processing device 300 such as smartphone 104 of FIG. 1. Components of the digital data processing device 300 suitably include one or more processors, illustrated by processor 304, memory, suitably comprised of read-only memory 310 and random access memory 312, and bulk or other non-volatile storage 308, suitably connected via a storage interface 306. A network interface controller 330 suitably provides a gateway for data communication with other devices, such as via wireless network interface 338. A user input/output interface 340 suitably provides display generation 346 providing a user interface via touchscreen display 344, suitably displaying images from display generator 346. It will be understood that the computational platform to realize the system as detailed further below is suitably implemented on any or all of devices as described above.

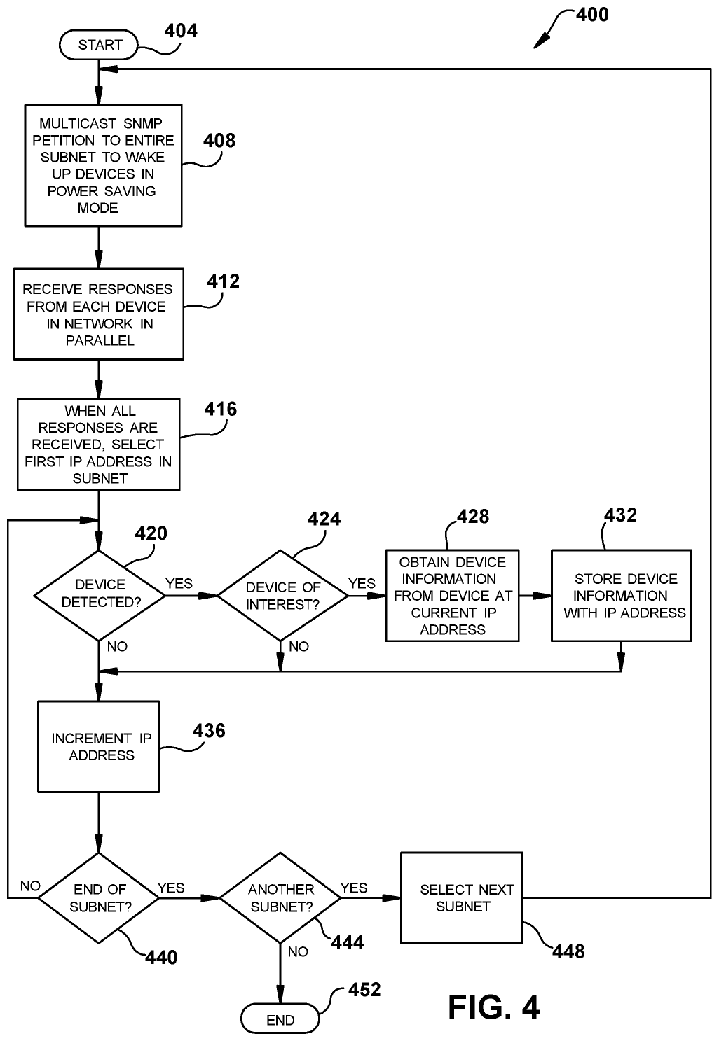

FIG. 4 is a flowchart 400 of an example embodiment of a system for mobile device fleet management. The process commences at block 404 and proceeds to block 408 wherein a multicast SNMP petition is broadcast across a subnet. The initial subnet is that in which a mobile device is present. Replies from network devices are received in parallel in block 412. While it is possible to broadcast a petition concurrently to all devices on a subnet, receiving in parallel asynchronous responses may overwhelm resources or capabilities of a portable data device. In such instances, a multicast petition can be broken into sending petitions to subsets of devices on the subnet until all are queried. By way of example, a device may have sufficient resources to process 50 concurrent replies, so 50 petitions can be sent out at a time, with the next 50 being sent when the prior 50 have been processed and stored, continuing until the entire subnet is covered. A particular number is based on factors such as processor speed, network or network connection capacity or available device memory. A number is suitably preselected from known device capabilities. A number may also be determined by a processor querying its own capabilities, measuring availability of memory or running a network speed test. A number of concurrent petitions is also suitably refined periodically to adapt to changing device or network conditions.

Next, at block 416, once all responses are received and stored, IP addresses in the subnet are traversed, starting with the first IP address of the subnet.

Next, a determination is made at block 420 as to whether a device was detected at the current IP address. If so, a test is made at block 424 to determine if it is a device of interest, such as an SNMP capable MFP. If so, device information is queried via a second petition to the device at block 428. Device information from the MFP reply is received and stored at block 432, and the current IP address is incremented at block 436. If a device is determined not to be of interest in block 424, the process proceeds immediately to block 436.

A test is made at block 440 to determine if all IP addresses in the subnet have been checked. If not, the process returns to block 420 with the incremented IP address. Once an end of the subnet is achieved at block 440, the system progresses to block 444 and a check is made as to whether another subnet is to be processed. If so, a next subnet is selected at block 448 and the system returns to block 408. When a last subnet is determined at block 444, the system ends at block 452.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
a network interface;
memory;
a processor configured for data communication with a network subnet via the network interface;
the processor further configured to send a multicast petition to addresses in the network subnet via the network interface;
the processor further configured to receive asynchronous responses in parallel from devices in the network subnet responsive to the multicast petition;
the processor further configured to store received responses in the memory;
the processor further configured to sequentially determine, once all responses have been received, from each stored response whether an associated device is of interest;
the processor further configured to send a second petition for device information to each device determined to be of interest;
the processor further configured to receive device state information from each device responsive to the second petition; and
the processor further configured to update a device management database in accordance with received device state information.

2. The system of claim 1 wherein the processor is further configured to send the multicast petition in multiple iterations to a number of devices for which a mobile data device comprising the processor, the memory and the network interface has resources sufficient to process the asynchronous responses in parallel.

3. The system of claim 2 wherein received multicast petition responses include the device information, and wherein the processor is further configured to determine a device to be of interest when the device information identifies it as an SNMP capable multifunction peripheral.

4. The system of claim 3 wherein the second petition is comprised of SNMP query.

5. The system of claim 4 wherein the device state information includes one or more of installed software, installed hardware, firmware version, consumable level, error codes and device usage levels.

6. The system of claim 5 wherein the processor is further configured to sequentially, for one or more additional subnets:
to send the multicast petition to addresses in the one or more additional subnet via the network interface;
receive the asynchronous responses in parallel from devices in the one or more additional subnet responsive to the multicast petition;
store responses received from the one or more additional subnet in the memory;
sequentially determine, once all one or more additional subnet responses have been received, from each stored additional subnet response whether the associated device is of interest;
send the second petition for the device information to each device in the one or more additional subnet determined to be of interest;
receive the device state information from each device in the one or more additional subnet responsive to the second petition; and
update the device management database in accordance with the received device state information.

7. The system of claim 2 wherein the mobile data device is located in an identified subnet.

8. The system of claim 1 wherein the multicast petition is sent concurrently to all addresses in an identified subnet except for an address of a mobile data device comprising the processor, the memory and the network interface.

9. A method comprising:
communicating data with a network subnet via a network interface;
sending, via a processor, a multicast petition to addresses in the network subnet via the network interface;
receiving asynchronous responses in parallel from devices in the network subnet responsive to the multicast petition;
storing received responses in memory;
sequentially determining, once all responses have been received, from each stored response whether an associated device is of interest;
sending a second petition for device information to each device determined to be of interest;
receiving device state information from each device responsive to the second petition; and
updating a device management database in accordance with received device state information.

10. The method of claim 9 further comprising sending the multicast petition in multiple iterations to a number of devices for which a mobile data device comprising the processor, the memory and the network interface has resources sufficient to process asynchronous responses in parallel.

11. The method of claim 10 wherein received multicast petition responses include the device information, and further comprising determining a device to be of interest when the device information identifies it as an SNMP capable multifunction peripheral.

12. The method of claim 11 wherein the second petition is comprised of SNMP query.

13. The method of claim 12 wherein device state information includes one or more of installed software, installed hardware, firmware version, consumable level, error codes and device usage levels.

14. The method of claim 13 further comprising sequentially, for one or more additional subnets:
sending the multicast petition to addresses in the one or more additional subnet via the network interface;
receive the asynchronous responses in parallel from devices in the one or more additional subnet responsive to the multicast petition;
storing responses received from the one or more additional subnet in the memory;
sequentially determining, once all additional subnet responses have been received, from each stored additional subnet response whether the associated device is of interest;
sending the second petition for the device information to each device in the additional subnet determined to be of interest;
receiving the device state information from each device in the additional subnet responsive to the second petition; and
updating the device management database in accordance with the received device state information.

15. The method of claim 10 wherein the mobile data device is located in an identified subnet.

16. The method of claim 9 wherein further comprising sending the multicast petition concurrently to all addresses in an identified subnet except for an address of a mobile data device comprising the processor, the memory and the network interface.

17. A system comprising:
a network interface;
a processor configured to determine a network address associated with the network interface;
the processor further configured to send a multicast petition to all remaining addresses in a subnet associated with a determined network address;
the processor further configured to receive asynchronous responses in parallel from devices in the subnet responsive to the multicast petition, wherein each response identifies an associated device type;
the processor further configured to store received responses in memory;
the processor further configured to sequentially send a second petition to each device identified as a multifunction peripheral by its device type, the second petition including a query for device state data.

18. The system of claim 17 wherein device state information includes device configuration information or device capability information.

19. The system of claim 18 wherein the second petitions are comprised of SNMP queries.

20. The system of claim 19 wherein the processor is further configured to send the multicast petition in multiple iterations to portions of the subnet to limit a number of parallel received asynchronous responses in accordance with available system resources.
